(19) United States
(12) Patent Application Publication
(10) Pub. No.: US 2011/0250797 A1
(43) Pub. Date: Oct. 13, 2011

(54) CABLE ASSEMBLY WITH IMPROVED TERMINATING MEANS

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/081,508

(22) Filed: Apr. 7, 2011

(30) Foreign Application Priority Data
Apr. 7, 2010 (CN) 201020151992.5

(51) Int. Cl. H01R 24/00

(52) U.S. Cl. 439/660

(57) ABSTRACT

A cable assembly (1000) includes an insulative housing (11); a cable (14) having an insulative jacket and a plurality of wires (141) enclosed by the insulative jacket; a plurality of contacts (13) mounted to the insulative housing, and each of the contacts having a retention portion, a mating portion and a tail portion (1313, 1323), the tail portion having a taper end (1316, 1326) and a longitudinal slot (1318, 1328) defined in the tail portion to divide the tail portion into two branches, and the tail portion inserted into a corresponding wire along an axial direction.

### BACKGROUND OF THE INVENTION

1. Field of the Invention

The present invention relates to a cable assembly, especially to a cable assembly with improved terminating means. The application relates to a copending application having the same filing date, the same title, the same inventors and the same assignee with the instant application.

2. Description of Related Art

A cable assembly generally refers to a cable connected to a connector. The connector includes an insulative housing, a plurality of contacts mounted to the insulative housing and a cable having a number of wires with inner conductors respectively soldered to the contacts.

However, there are some problems of terminating the wires to the contacts by soldering process. First, the cable should be trimmed, i.e. a front part of a jacket of the cable should be removed away to expose the wires, and then an insulator outside of the corresponding wire should be stripped off so as to expose the inner conductors outside, and then the wires also should be organized as they are always in a mess state. It takes much time to terminate the wires to the contacts by soldering process. In addition, the soldering process may cause environment pollution.

Hence, an improved means for terminating the wires to the contacts is required to overcome the problems of the prior art.

### SUMMARY OF THE INVENTION

An object of the present invention is to provide terminating means for a cable assembly without soldering process.

Accordingly, to achieve above-mentioned object, a cable assembly comprises an insulative housing; a cable having an insulative jacket and a plurality of wires enclosed by the insulative jacket; a plurality of contacts mounted to the insulative housing, and each of the contacts having a retention portion, a mating portion and a tail portion, the tail portion having a taper end and a longitudinal slot defined in the tail portion to divide the tail portion into two branches, and the tail portion inserted into a corresponding wire along an axial direction.

Accordingly, to achieve above-mentioned object, a method of making a cable assembly comprises steps of: providing an insulative housing; providing a plurality of contacts and mounting the contacts to the insulative housing, with tail portions of the contacts disposed behind the insulative housing; providing a cable which has a number of wires and an insulative jacket enclosing the wires; adjusting relation between the cable and the contacts to have the wires respectively align with the tail portions of the contacts along an axial direction; moving the cable or the insulative housing to urge the tail portions penetrating into the wires along the axial direction.

The detailed features of the present invention will be apparent in the detailed description with appropriate reference to the accompanying drawings.

### BRIEF DESCRIPTION OF THE DRAWINGS

FIG. 1 is a perspective view of a cable assembly of in accordance with the present invention;

FIG. 2 is an exploded, perspective view of the cable assembly in FIG. 1;

FIG. 3 is similar to FIG. 2, but viewed from other aspect;

FIG. 4 is an enlarged view of contacts; and

FIG. 5 is a cross-section view of the FIG. 1 taken along a line 5-5.

### DETAILED DESCRIPTION OF THE INVENTION

Reference will now be made in detail to the preferred embodiment of the present invention.

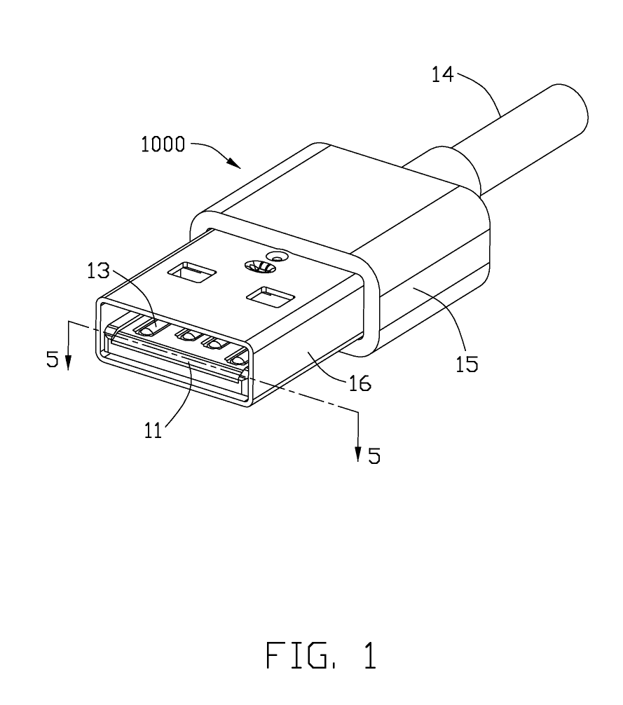

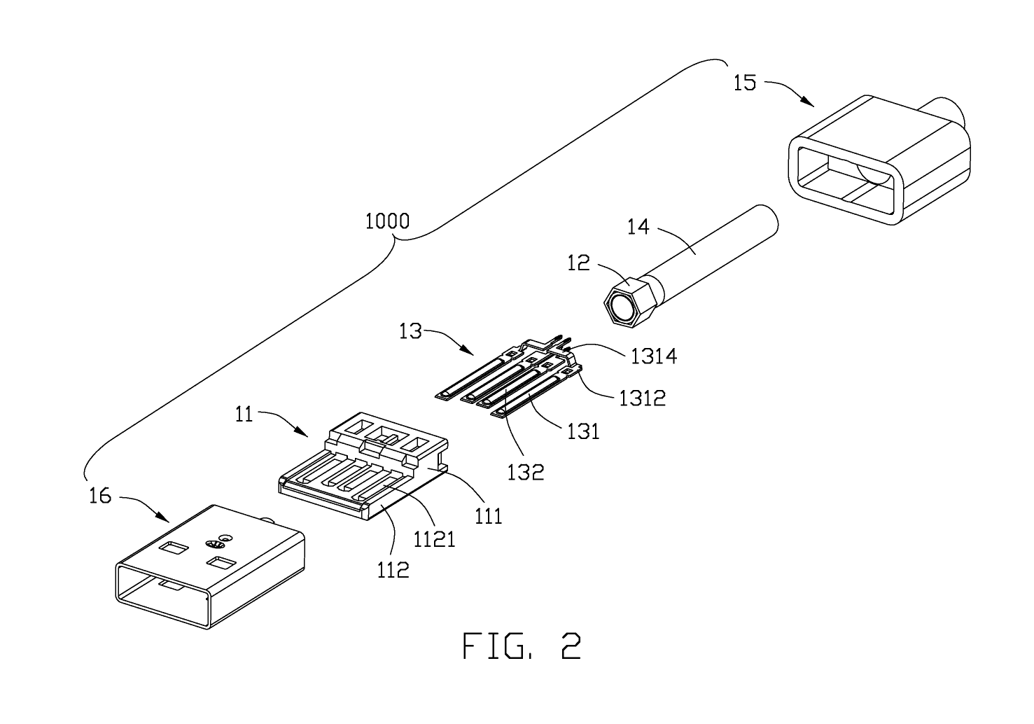

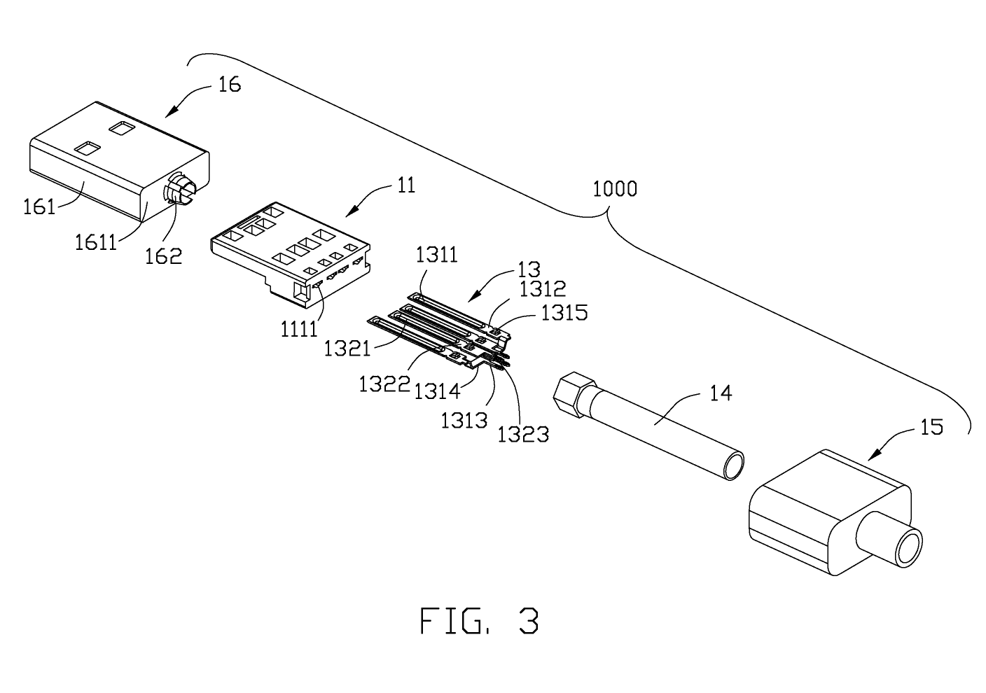

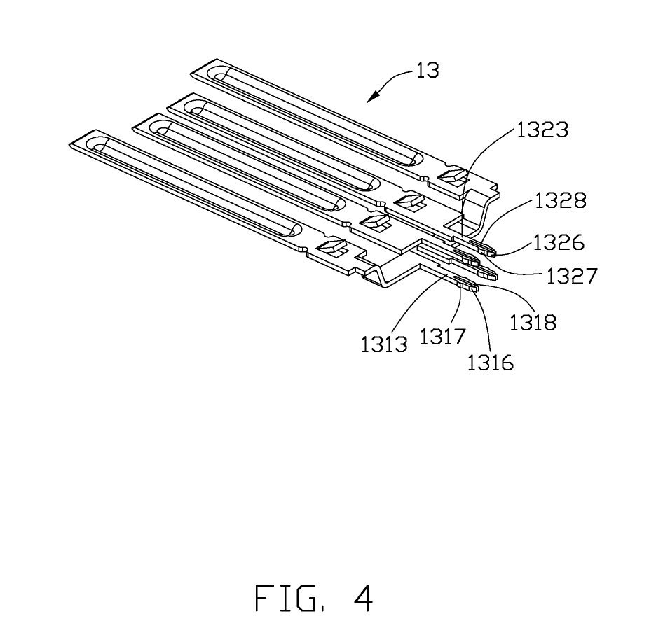

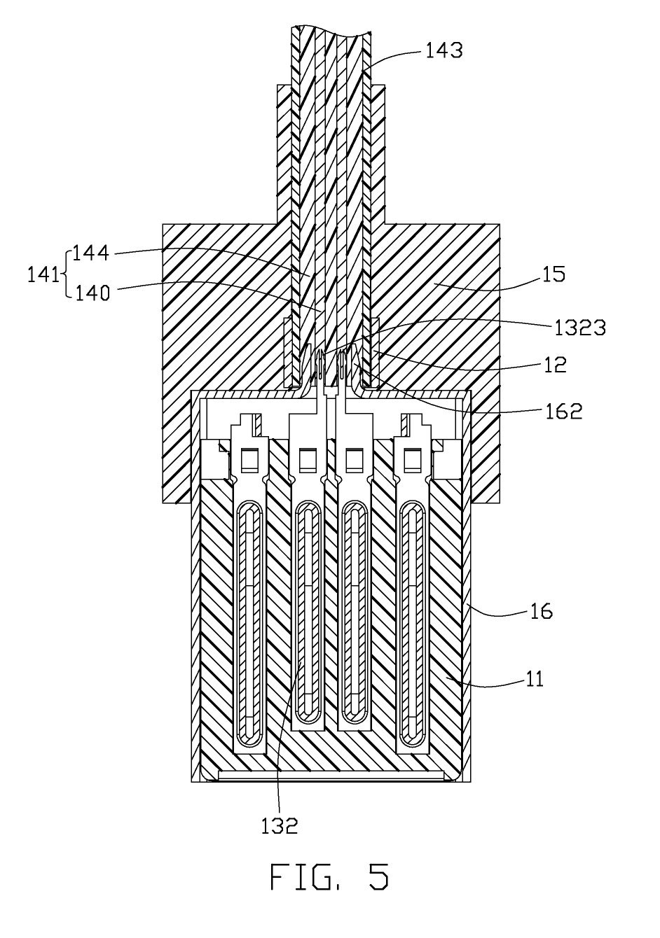

Referring to FIGS. 1-5, a cable assembly 1000 in accordance with the present invention is compatible with Universal Serial Bus (USB). The cable assembly 1000 includes an insulative housing 11, a ferrule 12, a plurality of contacts 13, a cable 14, an insulative cover 15 and a metallic shell 16.

The insulative housing 11 has a base portion 111 and a tongue portion 112 extending forwardly from the base portion 111. The base portion 11 is thicker than the tongue portion 112. There are a number of slots 1111 defined in the base portion 111 and extending along a front to back direction. Also, a number of grooves 1121 are located in a top side of the tongue portion 112 and align with the slots 1111, respectively. Both the slots 1111 and the grooves 1121 are arranged in a row along a transversal direction.

There are four contacts 13 of the embodiment. Two first contacts 131 are disposed at opposite sides and two second contacts 132 located between the two first contacts 131. Each first contact 131 has a retention portion 1312, a mating portion 1311 extending forwardly from the retention portion 1312, a L-shaped mediate portion 1314 raised from a back portion of the retention portion 1312 and extending inwardly therefrom, and a tail portion 1313 extending backwardly from an end of the mediate portion 1314. The tail portion 1313 has a taper/sharp free end. In addition, there are two protrusions 1317 formed at opposite lateral sides of the tail portion 1313. Each protrusion 1317 has an arc shaped outer surface. Also, a longitudinal slot 1318 is defined in the tail portion 1313 to divide the tail portion 1313 into two branches both extending along an axial or longitudinal direction and deformable along a transversal direction which is perpendicular to the longitudinal direction; and therefore each branch has a pointed end. Each second contact 132 has a retention portion 1322, a mating portion 1321 extending forwardly from the retention portion 1322, and a tail portion 1323 extending backwardly from an end of the retention portion 1322. The tail portion 1323 has a taper/sharp free end. In addition, there are two protrusions 1327 formed at opposite lateral sides of the tail portion 1323. Each protrusion 1327 has an arc shaped outer surface. Also, a longitudinal slot 1328 is defined in the tail portion 1323 to divide the tail portion 1323 into two branches both extending along an axial or longitudinal direction and deformable along a transversal direction which is perpendicular to the longitudinal direction; therefore each branch has a pointed end. Each branch has a pointed end. In addition, there is a barb 1315/1325 upwardly projects from the retention portion 1312/1322. Two tail portions 1313 of the two first contacts 131 are disposed adjacent to each other and arranged at a first level. Two tail portions 1323 of the two second contacts 132 are disposed adjacent to each other and arranged at a second level which is under the first level. A distance between the tail portions 1313 of the first contacts 131 is equal to a distance between the tail portions 1323 of the second contacts 132. Of course, the number of the first contacts 131 and the second contacts 132 may be more than two. By such arrangement, tail portions 1313/1323 are compact. The contacts 13 are assembled to the insulative housing 11 along a front-to-back direction, with the mating portion 1311/1321 accommodated in the corresponding groove 1121, the retention portion 1312/1322 inferentially received in the corresponding slot 1111, and the tail portion 1313/1323 disposed behind the base portion 111 of the insulative housing 11.

The cable 14 is a round type cable, which includes four wires 141 and an insulative jacket 143 enclosing the wires 141. Each wire 141 has an inner conductor 140 with a layer of outer insulator 144 shielding the inner conductor 140.

The metallic shell 16 has a rectangular shaped frame portion 161 and a cylindrical shaped extension portion 162 projecting backwardly from a back wall 1611 of the frame portion 161.

When assembly, the insulative housing 11 is mounted into the frame portion 161 and the tail portions 1313, 1323 are disposed in the extension portion 162, then by adjusting the cable 14 and having the wires 141 aligning with the tail portions 1313/1323 along an axial direction, pushing the insulative housing 11 backwardly movement to let the tail portions 1313, 1323 inserting/penetrating into the wires 141 along the axial direction of the cable 14, thus the tail portions 1313, 1323 respectively contacting with the inner conductors 140 of the wires 141 to form electrical connection therebetween. The extension portion 162 is inserted into the outer insulator 144 of then cable. The ferrule 12 is mounted/crimped to an outside of the insulative jacket 143 after the tail portions 1313, 1323 terminated to the cable 14. Finally, the insulative cover 15 is molded over a back segment of the metallic shell 16, a front segment of the cable 14 and the ferrule 12.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
an insulative housing;
a cable having an insulative jacket and a plurality of wires enclosed by the insulative jacket;
a plurality of contacts mounted to the insulative housing, and each of the contacts having a retention portion, a mating portion and a tail portion, the tail portion having a taper end and a longitudinal slot defined in the tail portion to divide the tail portion into two branches, and the tail portion inserted into a corresponding wire along an axial direction.

2. The cable assembly as claimed in claim 1, wherein the two branches extend along the axial direction.

3. The cable assembly as claimed in claim 1, wherein the two branches are deformable along a transversal direction which is perpendicular to the axial direction.

4. The cable assembly as claimed in claim 3, wherein there is a protrusion formed on each branch.

5. The cable assembly as claimed in claim 4, wherein the protrusion is located at lateral side of the branch.

6. The cable assembly as claimed in claim 4, wherein the protrusion has an arc shaped outer surface.

7. The cable assembly as claimed in claim 4, wherein there is a ferrule crimped to the insulative jacket to retain the wires and the tail portions therein.

8. The cable assembly as claimed in claim 7, wherein the protrusion on the tail portion is enclosed by the ferrule.

9. The cable assembly as claimed in claim 1, wherein the contacts includes first contacts and second contacts, and the mating portions of the first contacts and second contacts are arranged in a row, and the tail portions of the first contacts and the second contacts are spaced apart from each other along a vertical direction.

10. The cable assembly as claimed in claim 9, wherein there are two first contacts and two second contacts disposed between the two first contacts, first contact further has a mediate portion connecting the retention portion and the tail portion, and the mediate portion extends upwardly and inwardly from the retention portion.

11. The cable assembly as claimed in claim 10, wherein the mediate portion is L-shaped.

12. A cable assembly, comprising:
an insulative housing;
a plurality of contacts mounted to the insulative housing, and each of the contacts having a retention portion, a mating portion and a tail portion, the tail portion divided into two branches by a longitudinal slot defined thereon;
a metallic shell including a frame portion enclosing the insulative housing and an extension portion projecting backwardly from the frame portion;
a cable having an insulative jacket and a plurality of wires enclosed by the insulative jacket; and
wherein the tail portions of the contacts are inserted into corresponding wires along an axial direction;
wherein the extension portion is inserted into the cable.

13. The cable assembly as claimed in claim 12, wherein the extension portion is of cylindrical shaped, and tail portions extend into the extension portion before inserted into the corresponding wires.

14. The cable assembly as claimed in claim 12, wherein each branch of the tail portion has a tapered end.

15. The cable assembly as claimed in claim 12, wherein there is a ferrule crimped to the insulative jacket to enclose the extension portion and the tail portions of the contacts.

16. A cable connector assembly comprising:
an insulative housing defining a front mating portion and rear mounting portion in a front-to-back direction;
a metallic shell enclosing the housing and cooperating with the mating portion to define a mating port;
a plurality of contacts disposed in the housing with front contacting sections exposed in the mating port and rear tail sections around the rear portion wherein the front contacting sections are arranged in one row along a transverse direction perpendicular to said front-to-back direction while the tail sections are arranged in a bundle; and
a cable including a plurality of wires in a bundle; wherein
the tail sections pierce into the corresponding wires axially.

17. The cable connector assembly as claimed in claim 16, wherein the cable includes an insulator enclosing the wires, and the shell defines an axial extension pierces into the insulator axially.

18. The cable connector assembly as claimed in claim 16, wherein there are four contacts including two outer ones and two inner ones under condition that the tail sections of the two inner ones are aligned with the corresponding contact sections in the front-to-back direction while those of the two outer ones are offset from the corresponding contact sections in both the transverse direction and a vertical direction perpendicular to both the front-to-back direction and the transverse direction.

19. The cable connector assembly as claimed in claim 16, wherein the tail section defines a lateral protrusion.

20. The cable connector assembly as claimed in claim 19, further including a deformable ferrule crimped upon the cable around the tail sections so as to have said lateral protrusion efficiently retained within the cable.
